(19) United States
(12) Patent Application Publication
(10) Pub. No.: US 2008/0143720 A1
(43) Pub. Date: Jun. 19, 2008

(54) Method for rendering global illumination on a graphics processing unit

(75) Inventor: Kells A. Elmquist, Lansing, NY (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Autodesk, Inc.

(21) Appl. No.: 11/638,139

(22) Filed: Dec. 13, 2006

(51) Int. Cl. G06T 15/50

(52) U.S. Cl. 345/426; 345/427

(57) ABSTRACT

A method, apparatus, and article of manufacture provide the ability to conduct global illumination. A three-dimensional (3D) model of a scene is obtained in a computer graphics application. A section of the scene is identified as a region of interest. A photon tree is then obtained that consists of a set of buffers that represents the region of interest, with every pixel in the region of interest necessary for every view being represented in at least one buffer in the set of buffers. The set of buffers are concatenated into a single large buffer. One or more full screen draw operations is performed over the single large buffer. The draw operation performs a lighting and optional shadowing operation on every pixel represented in the set of buffers. Any view of the region of interest is then displayed based on the lighting information thus incorporated into the photon tree.

### BACKGROUND OF THE INVENTION

1. Field of the Invention

The present invention relates generally to lighting a three-dimensional (3D) model. More specifically, the invention is directed towards improving the rendering speed for globally-lit scenes, on models of arbitrary complexity using a video graphics processing unit (GPU).

2. Description of the Related Art

Systems for doing real-time walkthroughs of complex 3D models have traditionally been limited by scene complexity, realism of the rendering scheme used, and the number of lights. In particular, real-time performance with global lighting has been difficult to achieve. Accordingly, what is needed is a method and system for improving rendering speed for a scene regardless of the complexity of the 3D model. These problems may be better understood with a description of prior art lighting techniques.

Many applications desire to display or walk-through extremely large and complex 3D models. For example, an entire city may be placed in a model, and the application desires to display various sections/parts of the city while a user walks through the city. Such a model may involve hundreds of millions of polygons. However, due to memory restrictions, information must be paged to and from disk during such a display operation.

The prior art utilizes a variety of techniques to manage such information in memory. For example, a visibility system may be used wherein only information that is needed for viewing or actual display is stored in memory. In such an implementation, the only data stored in memory is that data needed for the application to currently view data or that might be viewed in the near future. However, such visibility systems have many limitations. For example, while the prior art may have the ability to handle large models and a variety of textures on such models, only a single light may be used to illuminate a scene. To accurately reflect a real-world scene, sophisticated lighting with multiple lights that illuminate various portions of a scene are necessary. Further, an application must have the ability o incorporate shadows and other high level effects.

Ray Tracing

Various prior art techniques are utilized to light a scene. Ray tracing is a technique that models the path taken by light by following rays of light as they interact with optical surfaces. In a 3D graphics environment, ray tracing follows rays from the eyepoint outward, rather than originating at a light source. Thus, visual information on the appearance of the scene is viewed from the point of view of the camera, and lighting conditions specified are interpreted to produce a shading value. The ray's reflection, refraction, or absorption are calculated when it intersects objects and media in the scene.

Ray Casting

Another prior art technique is that of ray casting. Ray casting is similar to ray tracing. However, in ray casting, new tangents a ray of light might take after intersecting a surface on its way from the eye to the source of light are not calculated. Thus, the possibility of accurately rendering reflections, refractions, or the natural fall off of shadows cannot be accurately calculated. Nonetheless, texture maps or other methods may be used in an attempt to simulate such shadows.

Radiosity

Another prior art technique is that of radiosity which attempts to capture diffuse indirect illumination in a scene. In other words, radiosity attempts to simulate the many reflections of light around a scene, resulting in softer, more natural shadows. In radiosity, when light shines through a window, it shines on the floor and bounces off of the floor and illuminates the ceiling. Thus, while there is no direct light on the ceiling, the ceiling is not black because it is illuminated from secondary light sources. However, such lighting is more than a mere single reflection or refraction. Radiosity attempts to model environments where every point on every surface is lit by every other point that is visible to it, while simultaneously providing some lighting to each of those same points.

The ability to capture such illumination, whether radiosity or otherwise, is difficult. To determine the diffuse light at a single point, the application must maintain information about all of the objects in the environment that are illuminating the point (i.e., to account for radiosity), the visibility of each from the receiving point of view, and the diffuse illumination at each visible point. However, each such point is also receiving light from everywhere and a simple mapping is not possible because one must know the light falling on all of the points on all objects to determine the lighting at any one particular point.

Photon Mapping

Photon mapping may also be used to solve illumination problems. Photon mapping is noted for its ability to handle caustics (specular indirect effects) (e.g., rather than radiosity which is for diffuse indirect effects) as well as diffuse inter-reflection. Photon mapping uses ray tracing to deposit photons from the light sources into objects in the scene. The photons are stored in a binary space partitioning (BSP) tree data structure where neighbors can be simply discovered & photons merged to constrain memory use. BSP is a method for recursively subdividing a space into convex sets by hyperplanes. The subdivision gives rise to a representation of the scene by means of a tree data structure referred to as the BSP tree. In the case of reflective or refractive objects, new photons are generated from the incoming set and sent into the environment, again using ray tracing, and the resulting caustic photons are added to the tree. It should be noted that each photon may be viewed as a separate data structure that contains information including the direction the photon came from, where the photon hits a surface, and reflection properties at the surfaces.

A photon mapping algorithm usually proceeds in two phases. First a coarse illumination solution is prepared as described above. Second, the coarse illumination is “gathered”, pixel by pixel, to produce a smooth final output. This gathering step requires many rays for quality results and is the subject of much research.

Progressive Radioisty

Another solution to solving illumination is progressive radiosity. Progressive radiosity attempts to simulate photon mapping through radiosity. The brightest light source is examined first and projected into the environment. The light is gathered into auxiliary data structures at the projected locations in the environment. At render time, the data structures are examined and accessed. However, a photon data structure may not be used. Instead, a color per vertex of the model is stored. The vertex is lit and interpolated across a polygon. Such radiosity algorithms are limited in their ability to simulate direct lighting because of the limited resolution at vertices. If sharp shadows are desired, for example, the model must be changed to produce more vertices. Accordingly, if a lighting algorithm requires an adjustment to the geometry, extensive processing is necessary and the system may be inefficient.

All of the above described illumination solutions have various problems. For example, in ray tracing and/or photon mapping, to walk through a very large model, the memory usage may reach the maximum capacity. Accordingly, it is not possible to have large central processing unit (CPU) based memory structures (e.g., photons). To overcome such memory issues, some applications may allocate and use the graphics processing unit (GPU) memory to store some of the sampling of the scene and to conduct computations for indirect illuminations.

Shaders

In addition to the above, many applications render images utilizing shaders. A shader is a computer program used in 3D computer graphics to determine the final surface properties of an object or image. A shader often includes arbitrarily complex descriptions of various properties such as light absorption, reflection, refraction, shadowing, etc.

Various types of shaders exist. A vertex shader is applied for each vertex and runs on a programmable vertex processor. Vertex shaders define a method to compute vector space transformations and other linear computations. A pixel shader is used to compute properties that, most of the time, are recognized as pixel colors. Pixel shaders are applied for each pixel and are run on a pixel processor using values interpolated from the vertices as inputs.

A shader (e.g., a pixel shader) may work locally on each point that is rendered. In this regard, given the location and attributes of one point on a surface, the shader returns the color on that point. In addition, shading algorithms are often based on the concept of multiple passes. A shader, at its highest level, is a description of how to render an object multiple times to achieve a particular effect that is not possible with only a single rendering pass. Multiple passes can describe more complex effects than single passes since each rendering pass can be different from the other rendering passes. The results of each pass may be used as input to the next pass, or are combined in the frame buffer with the previous passes. For example, if it is desirable to render an object with two textures but the hardware only supports the ability to render one texture at a time, the object can be rendered once for each texture (i.e., a pass is performed for each texture) and the results are added together.

It may often be necessary to evaluate neighboring pixels. However, if you have a shader that works on a surface, such neighbor examination is more difficult or impossible. In a shader, one cannot examine neighboring pixels during a single pass of the shader. Instead of rendering to the frame buffer that is presented to the user (i.e., rendering to the screen), a pass renders to an off-screen texture. In subsequent passes, the previously rendered bitmaps may be sampled/examined (e.g., given a particular UV coordinate, the value of the texture can be looked-up). However, there is no mechanism for obtaining the value of neighboring pixels from the frame buffer in the same/current pass.

Deferred Shading and the G-Buffer

Modem games (and other applications such as image processing applications) use many lights on many objects covering many pixels (which is computationally expensive). There are three major options for conducting real-time lighting: (1) single-pass, multi light; (2) multi-pass, multi-light; and (3) deferred shading. Each method has associated trade-offs.

In single-pass lighting, for each object, the object is rendered, applying all of the lighting in a single shader. Such a solution is difficult in multi-light situations because shader complexity is limited and there may be many lights.

In multi-pass lighting, an operation is conducted for each light. The operation analyzes each object affected by the light, and increases the frame buffer based on the object and the light. Such operations can cause wasted shading (e.g., with hidden surfaces) and there is repeated work each pass with respect to vertex transformation and setup.

Deferred shading makes use of a g-buffer. The idea of the g-buffer, or geometry buffer, has been around for many years. This scheme uses normal rasterization mechanisms to produce a buffer not of final color values, but of the geometric values and other variables needed to compute those final colors. Video games often utilize deferred shading to produce the main/primary scene. Further, 3DS Max™ (available from the assignee of the present invention) has a g-buffer that allows users to store position, normal, depth, UV, etc. for each pixel and access the information to provide advanced effects.

In deferred shading, for each object, the lighting properties are rendered to the g-buffer. Such lighting properties include the position and the normal of every point from a particular point of view. For each light, the final color is increased based on its prior value and the result of the interaction of the surface material and the light. Thus, the complexity for lighting is reduced and lots of small point-to-point light transfers may be rendered easily.

As a result, instead of drawing the final color the light and material together, essential properties about the geometry are stored in the g-buffer (e.g., the position, normal, and color/material). The information in the g-buffer is then used as an input texture in another pass and a large quad the same size as the buffer is drawn. Accordingly, a single pixel in the g-buffer is examined and the shading is applied to the pixel and written to the output where it is accumulated.

Thus, deferred shading may be viewed as a GPU adaptation of the g-buffer idea to allow fast accumulation of illumination from many lights or light samples. It works for a single view by preparing a g-buffer from the eye point containing world space position, normal, and raw color. Since the solution is view specific, specular effects may also be included by including specular amplitude & sharpness in the buffer.

Using the g-buffer as input textures, lights are applied to the scene by drawing a single quad over the entire g-buffer, and having the pixel shader apply illumination from a new light sample to each pixel in the buffer. In this way, the original geometry need only be accessed once to build the g-buffer. Subsequently, any number of lights can be applied with the results accumulated in a final target. One drawback is that if lights are shadowed, the geometry must be traversed & rasterized to prepare the shadow buffer.

Deferred shading may be a fundamentally good idea for large scenes and for GPU based multi-pass accumulation. Further, deferred shading is the basis of dynamic re-lighting programs utilized by many animation companies. Also, deferred shading has the side benefit of natural support for the architectural separation between light shaders and surface shaders.

In view of the prior art described above, various problems or difficulties may arise. Further, none of the prior art solutions provide a complete and efficient approach to lighting. In this regard, from a system perspective, it is desirable to have the following capabilities:

(1) Advanced lighting of very large models (often>100M facets) at interactive rates;

(2) Compact local data structure for lighting information that does not impact the model size in memory;

(3) “Local lighting” solution that can be quickly computed, used for display and then replaced by a solution for a new region, or an improved solution for the current region. The local solution should be view independent for views within the local area;

(4) A method for handling animated objects within the local solution;

(5) High Dynamic Range (HDR) support for all computations;

(6) Quick runtime access method for interactive display;

(7) Accurate reflection & refraction of local objects;

(8) Scene adaptive, automatic method;

(9) No banding, noise or other visible artifacts in final images, some noise is permissible for interactive work;

(10) Stable solution under animation;

(11) Smooth and plausible degradations or errors; and

(12) Fast processing—all computations and data on the GPU if possible, no pre-computation if possible.

Similarly, from a lighting perspective, it is desirable to have

(1) Many, many, many lights;

(2) Dynamic re-lighting for interactive light placement;

(3) Arbitrary light distributions, manufacturer data, cookies, gobos, etc.

(4) Physically accurate soft shadows;

(5) Correctly shadowed diffuse inter-reflection, radiosity;

(6) Support for diffuse transmission through homogenous and non-homogenous materials, translucency;

(7) Support for sub-surface scattering on homogenous and non-homogenous materials, skin and multi-layer materials;

(8) Specular transmission of light, one & two surface, refractive caustics;

(9) Specular reflection of light, reflective caustics; and

(10) Participating media, fog, smoke, atmosphere, etc.

### SUMMARY OF THE INVENTION

One or more embodiments of the invention satisfy all of the above-identified options for both a system perspective and lighting perspective. The invention offers both diffuse indirect effects (radiosity) and specular indirect effects (caustics). Further, the output may be used directly on the GPU, or as a GPU assisted pre-processing step for software rendering. The invention is unique both in being GPU based and in its ability to handle extremely large models.

Embodiments of the invention use a GPU and combine the use of photons with deferred shading and a geometry buffer. A set of buffers are concatenated into a single large buffer such that a single full screen draw, without reference to any geometry, may perform a lighting step on every photon in every buffer. The result provides a view independent computation of illumination. Thus, shading values are produced for any pixel in any viewpoint with a single draw operation.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 illustrates the components of a computer system used in accordance with one or more embodiments of the invention;

FIG. 3 illustrates a 3D cube region of interest in accordance with one or more embodiments of the invention;

FIG. 4 illustrates the use of a splitting plane to subdivide a region of interest in accordance with one or more embodiments of the invention; and

FIG. 5 illustrates the logical flow for conducting global illumination in accordance with one or more embodiments of the invention.

### DETAILED DESCRIPTION OF THE PREFERRED EMBODIMENTS

In the following description, reference is made to the accompanying drawings which form a part hereof, and in which is shown, by way of illustration, several embodiments of the present invention. It is understood that other embodiments may be utilized and structural changes may be made without departing from the scope of the present invention.

### Observations

To better understand the invention, some observations on g-buffers and deferred shading are useful.

Storage Structure for Photons

Of the number of ways of looking at what a g-buffer actually is, one fruitful view is as a storage structure for a mass of photons. The structure uses the GPU rasterizer and z-buffer to produce all the first level ray intersections from a single point or parallel direction into the scene. Those same photon locations may be re-used to accumulate the light from the scene. As such, each g-buffer also represents a sampling of the scene, though incomplete. Also, a g-buffer has interesting properties as a storage structure, e.g. near neighbors are easy to find.

ViewPoint and Projection Independence

Another point about g-buffers is that, for diffuse lighting and indirect specular (caustics), once the geometry has been rasterized into the buffer, the shading environment for the pixel is entirely local to the pixel. Such pixel localization means that however the buffer was prepared, whether by parallel or perspective projection, and no matter what eye point was used for the rasterization of the buffer, all of those are irrelevant for the computation of diffuse direct & indirect illumination, as well as specular indirect illumination.

Concatenating Multiple Buffers

Considering the above-described view point independence, one may concatenate any desired number of buffers into a larger buffer of sufficient size and perform a light step on all buffers at once. Such a concatenation of buffers is a powerful notion.

The Light Field

In the general notion of a light field, a light field is any data structure that allows view independent computation of illumination. View independent is the key word here, meaning that unlike the deferred shading structure above that accumulates light only for a single view, a light field must be able to produce shading values for any viewpoint and view direction.

### Overview

Thinking of the g-buffer both as a photon buffer and a sampling of the scene, there exists some set of g-buffers that represent a “complete” sampling of the scene. Complete in this context means that the light field criteria above can be met, that at some given resolution, every pixel needed to make every view is available in at least one buffer in the set.

This set of buffers may be concatenated into a single large buffer such that a single full screen draw, without reference to any geometry, may perform a lighting step on every photon in every buffer—on the entire light field at once.

Since algorithms that decompose an arbitrary scene into such a set of buffers are usually hierarchically, (and because a photon map was taken), but without loss of generality, as used herein, all constructions of a set of g-buffers that satisfy the light field criteria are referred to as a “photon tree”. Many methods may be used to decompose a scene and construct a photon tree. One or more such methods are described herein.

An example of one particular method for decomposing a scene and constructing a photon tree involves adding split planes to a photon tree (see detailed description below). Due to the viewpoint independence properties of the invention, each time a new split plane is added to the photon tree, an independent decision may be made about the resolution to be used. This in turn allows samplings to be constructed that provides more detail in some areas, and thus supports algorithms that can detect areas of high lighting complexity and importance, requiring more g-buffer resolution to represent lighting only in some critical areas.

In addition, since operations on concatenated buffers are independent of how the buffers are prepared, operations and algorithms on an entire photon tree are identical regardless of how the sampling and buffer set is constructed, effectively isolating the two parts of the problem.

### Hardware and Software Environment

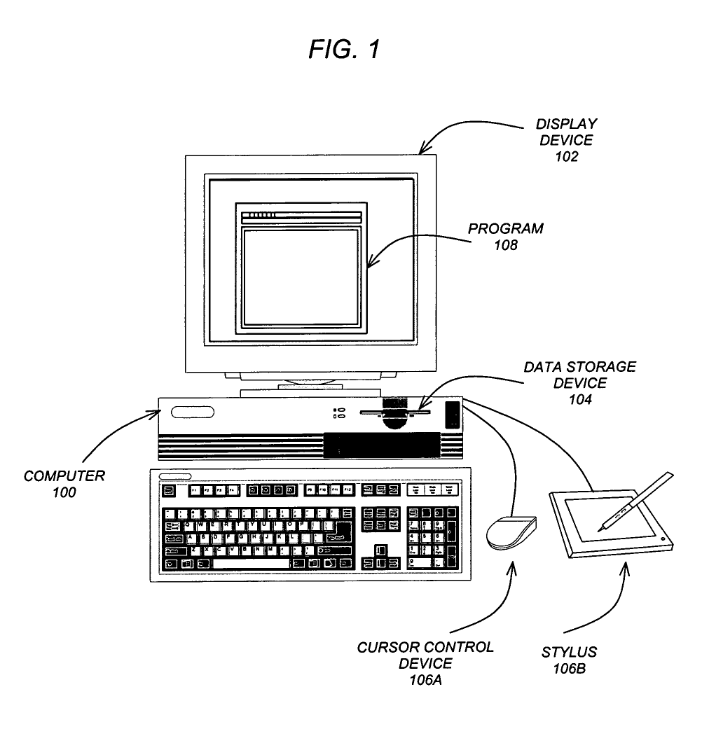

FIG. 1 is an exemplary hardware and software environment used to implement one or more embodiments of the invention. Embodiments of the invention are typically implemented using a computer 100, which generally includes, inter alia, a display device 102, data storage device(s) 104, cursor control devices 106A, stylus 106B, and other devices. Those skilled in the art will recognize that any combination of the above components, or any number of different components, peripherals, and other devices, may be used with the computer 100.

One or more embodiments of the invention are implemented by a computer-implemented program 108 (or multiple programs 108). Such a program may be a compiler, a parser, a shader, a shader manager library, a GPU program, or any type of program that executes on a computer 100. The program 108 may be represented by one or more windows displayed on the display device 102. Generally, the program 108 comprises logic and/or data embodied in/or readable from a device, media, carrier, or signal, e.g., one or more fixed and/or removable data storage devices 104 connected directly or indirectly to the computer 100, one or more remote devices coupled to the computer 100 via a data communications device, etc. In addition, program 108 (or other programs described herein) may be an object-oriented program having objects and methods as understood in the art. Further, the program 108 may be written in any programming language including C, C++, C#, Pascal, Fortran, Java™, etc. Further, as used herein, multiple different programs may be used and communicate with each other.

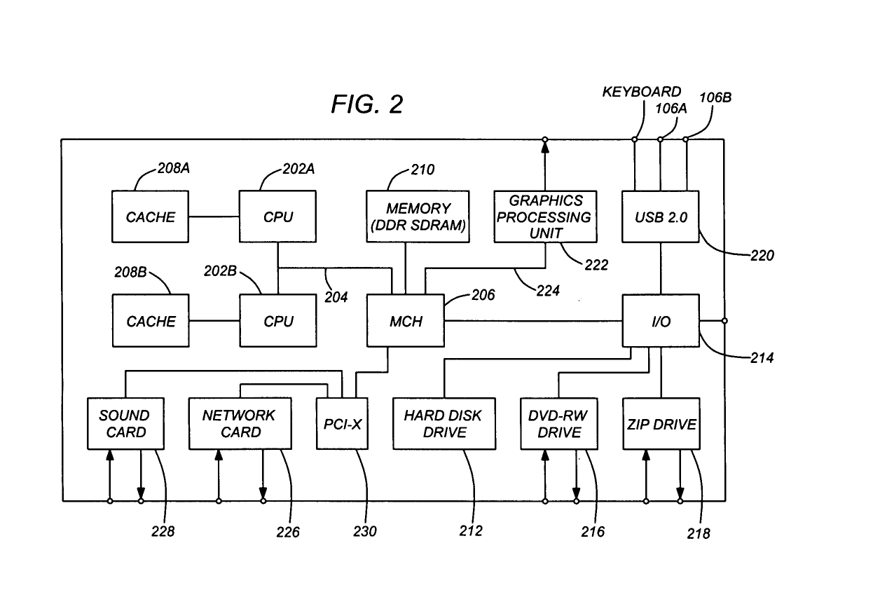

The components of computer system 100 are further detailed in FIG. 2 and, in one or more embodiments of the present invention, said components may be based upon the Intel® E7505 hub-based chipset.

The system 100 includes two central processing units (CPUs) 202A, 202B (e.g., Intel® Pentium™ Xeon™ 4 DP CPUs running at three Gigahertz, or AMD™ CPUs such as the Opteron™/Athlon X2™/Athlon™ 64), that fetch and execute instructions and manipulate data via a system bus 204 providing connectivity with a Memory Controller Hub (MCH) 206. CPUs 202A, 202B are configured with respective high-speed caches 208A, 208B (e.g., that may comprise at least five hundred and twelve kilobytes), which store frequently accessed instructions and data to reduce fetching operations from a larger memory 210 via MCH 206. The MCH 206 thus co-ordinates data flow with a larger, dual-channel double-data rate main memory 210 (e.g., that is between two and four gigabytes in data storage capacity) and stores executable programs which, along with data, are received via said bus 204 from a hard disk drive 212 providing non-volatile bulk storage of instructions and data via an Input/Output Controller Hub (ICH) 214. The I/O hub 214 similarly provides connectivity to DVD-ROM read-writer 216 and ZIP™ drive 218, both of which read and write data and instructions from and to removable data storage media. Finally, I/O hub 214 provides connectivity to USB 2.0 input/output sockets 220, to which the stylus and tablet 106B combination, keyboard, and mouse 106A are connected, all of which send user input data to system 100.

A graphics card (also referred to as a graphics processing unit [GPU]) 222 receives graphics data from CPUs 202A, 202B along with graphics instructions via MCH 206. The GPU 222 may be coupled to the MCH 206 through a direct port 224, such as the direct-attached advanced graphics port 8X (AGP™ 8X) promulgated by the Intel® Corporation, or the PCI-Express™ (PCIe) x16, the bandwidth of which may exceed the bandwidth of bus 204. The GPU 222 may also include substantial dedicated graphical processing capabilities, so that the CPUs 202A, 202B are not burdened with computationally intensive tasks for which they are not optimized.

Network card 226 provides connectivity to a framestore by processing a plurality of communication protocols, for instance a communication protocol suitable to encode and send and/or receive and decode packets of data over a Gigabit-Ethernet local area network. A sound card 228 is provided which receives sound data from the CPUs 202A, 202B along with sound processing instructions, in a manner similar to GPU 222. The sound card 228 may also include substantial dedicated digital sound processing capabilities, so that the CPUs 202A, 202B are not burdened with computationally intensive tasks for which they are not optimized. Network card 226 and sound card 228 may exchange data with CPUs 202A, 202B over system bus 204 by means of a controller hub 230 (e.g., Intel®'s PCI-X controller hub) administered by MCH 206.

Those skilled in the art will recognize that the exemplary environment illustrated in FIGS. 1 and 2 are not intended to limit the present invention. Indeed, those skilled in the art will recognize that other alternative environments may be used without departing from the scope of the present invention.

### Software Environment

A GPU 222 may utilize proprietary code (referred to as a GPU program) that customizes the operation and functionality of the GPU 222. As used herein, the term “GPU program” represents any and all types of programs that may be loaded and executed by a GPU 222, which includes (but is not limited to) fragment programs, vertex programs, and shaders or shader code (including fragment shaders, vertex shaders and pixel shaders).

GPUs 222 are efficient for rasterizing and building buffers. Accordingly, embodiments of the invention subdivide a scene into a number of buffers. As an example, consider a simple room scene such as a Cornell box or a cube. The basic environment of the Cornell box is one light source in the center of a white ceiling, a green right wall, a red left wall, a white back wall, and a white floor. Objects may also be placed into the scene (e.g., boxes or spheres). The physical properties of the box are designed to show diffuse inter-reflection wherein some light reflects off the red and green walls and bounce onto the white walls, so parts of the white walls should appear slightly red or green.

A simple decomposition (using the Cornell box) is a traditional six (6) buffer cube map prepared from the center of the scene. Accordingly, the walls, ceiling, floor and objects are all covered in a swarm of photons where they are visible in one of the six buffers. In other words, each of the buffers looks inward into the box/cube from the various sides of the box. To create a view from the center of the scene, the objects in the scene are projected, using a parallel projection, outwards onto the axis aligned buffers. In such a projection two coordinates of the objects position, offset by the buffer origin and scaled to account for sampling rate, may directly index the location of the same point in the g-buffer. If, for example, a cube face is aligned with the +Z plane, then the X and Y coordinates of the object's position, after a scale and offset, index the g-buffer for the same position.

Radiosity for the scene is computed stepwise on the six (6) concatenated buffers, one buffer draw per light sample. Sixty-four (64) samples of the direct area light may provide excellent direct illumination and soft shadows. The process is continued after the direct lighting is computed in the fashion of progressive radiosity (and/or instant radiosity) by sampling the accumulated illumination after the direct lighting pass many times, sorting the samples by energy and using the samples in energy order to continue shooting light into the scene. Accumulation results can be improved by periodically re-sampling and re-sorting the scene to include new radiosity passes. Care must be taken however to avoid shooting energy from the same spot twice when re-sampling.

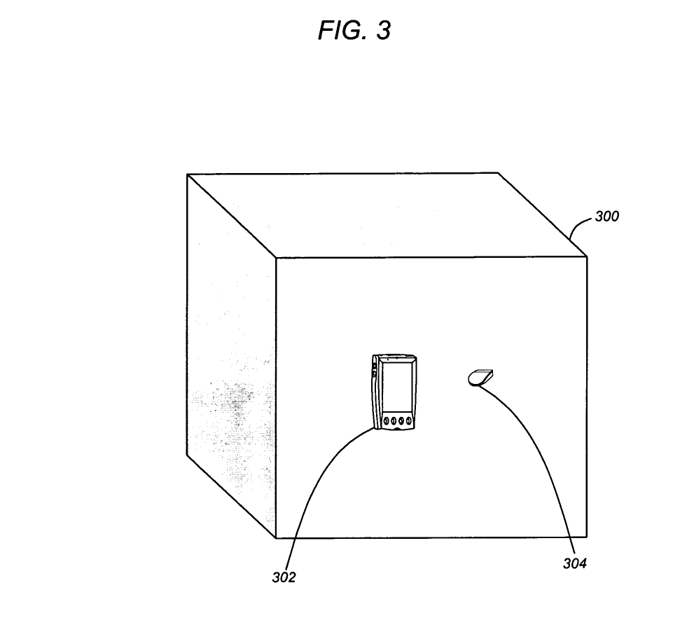

As given, the above approach has a number of drawbacks. Most important, not all sides of all the objects are covered in the cube map decomposition. FIG. 3 illustrates a 3D cube 300 with two objects—a PDA 302 and a mouse 304. If each side of the cube 300 is a buffer, you have six different views of the PDA 302 and mouse 304. However, if two objects are close together (e.g., the PDA 302 and mouse 304), when they are projected out, there is nothing for the interior between the two objects. Instead, the outsides of both objects 302 and 304 are obtained. Thus, if one were to walk in between the two object 302 and 304 and look outward towards one of the buffers, the data would be incorrect.

Similarly, if a simple object is placed in the middle of the cube, all six (6) faces/sides of the object may be projected. Accordingly, each point on the object will exist somewhere in three (3) of the projections (depending on which way the normal of the surface points. Referring again to the case of two close objects 302 and 304, the missing samples/sides of the objects have two effects. First, though the decomposition is valid for any view direction as long as the view point is at the cube center, as soon as the viewpoint moves off center, missing samples may appear in many views. Second, the missing samples impact the lighting as well—missing samples do not participate in sampling and sorting, so indirect illumination and color bleeding from these missing samples is never added to the scene.

To improve sampling of the scene one can split the cube into two sub-cubes by adding a split plane between the two (2) objects and preparing a pair of new buffers, one for each side of the new split plane. While this improves coverage, there may still be object areas occluded from all current views that still present problems.

From this it can be seen that most successful scene decompositions will be hierarchical in nature, adapting by subdivision to a given scene until the light field criteria is met. The description below sets forth details regarding the creation and use of such a hierarchical scene decomposition.

Projections

Various projections may be described and used herein. Such projections refer to the general operation of taking a three-dimensional (3D) scene and projecting its objects onto a two-dimensional (2D) plane. There are a number of ways to perform such a projection. The simplest projection is a parallel projection, where objects are projected in a parallel beam onto the projection plane. Note that for the special case of axis aligned parallel projections, the projected coordinates are just a re-ordering of the original coordinates: for projection to the yz plane, coordinates (x,y,z) become (y, z, x). Y and z become the buffer indices, while x gives the depth at the sample for z-buffering.

The second projection is a perspective projection, where all the view rays emanate from a single point. With a rectangular buffer this forms a quadrilateral pyramid projection beam. Perspective transforms can correctly resolve hidden surfaces from a single point. Cameras commonly use perspective projections, as do projections from the lights such as shadow maps. The projected coordinates are related to world space coordinates by a 4×4 matrix (referred to as the view matrix).

Cube maps are formed by six (6) perspective cameras that share a common viewpoint (the cube center) such that each camera is looking through one cube face. Often the cube is axis-aligned to simplify the computations. As such, the cube represents a complete (though discrete) spherical sampling of the scene about a single point, with all hidden surfaces resolved.

The last projection of interest samples an entire hemisphere in a single map, reducing the number of maps needed for a full sphere of directions from six (6) to two (2). Also, the sample distribution is more even than for cube maps. The problem with this projection is that it is accessed by a quadratic polynomial, and hence is not a linear space. This means that normal rasterization hardware may not be used to prepare buffers in this space, for while the vertex locations in the “hemi” space may be computed by a vertex shader, the GPU is not capable of interpolating facet edges and interiors in this warped non-linear space.

### Photon Tree

As described above, constructions of a set of g-buffers that satisfy the light field criteria are referred to as a “photon tree”. Various methods may be used to construct a photon tree. The invention provides at least one such method.

Photon Tree Characteristics

In one or more embodiments, a photon tree may have particular characteristics as set forth herein.

The photon tree is intended to be used on a section of a large scene referred to as the region of interest. This local solution is then embedded in an approximate “distant solution”.

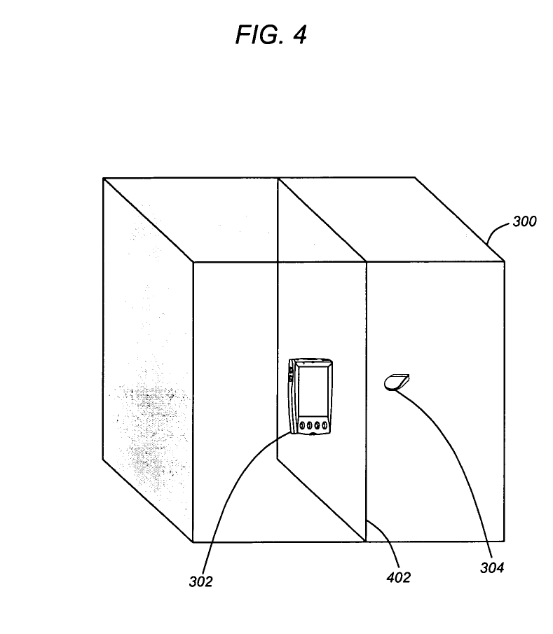

In addition, the photon tree uses a binary, space-filling, axis-aligned tree structure of g-buffers. In this structure, each box (e.g., the cube of FIG. 300) is split by a single splitting plane 402 of FIG. 4. FIG. 4 illustrates the use of a splitting plane to subdivide a region of interest in accordance with one or more embodiments of the invention. The plane 402 is always axis aligned, but the choice of axis and split point along the axis is used to optimize the tree for various properties.

All the buffers in the photon map are prepared using parallel, axis-aligned projections.

Each splitting plane 402 in the tree consists of two (2) buffers, that are formed by parallel projections on either side of the plane 402, the plane clipping the scene (e.g., the cube 300) into 2 halves.

Each buffer is composed of a number of channels. The world space position, world space normal, material index and raw color form the basic input channels. In addition, there are one or more accumulators for photon values. A material index comprises/consists of: comprises/consists of: an integer index into a set of property values for a material (eg. Diffuse color, specular color, specular power, ambient color, emissive color). Values for each of these components may be stored in the columns of a texture, with one row per full material specification; the material index gives the row of values to use for shading computations at the photon. These are sometimes augmented by a per-photon color (the raw color) to reduce the total number of material indices needed.

Construction of the tree begins by forming six (6) inward looking buffers on the cube faces of the region of interest. The missing six (6) outward looking buffers are discussed in more detail below. Subdivision of the region proceeds by a recursive procedure where each step:
Determines if the region needs division into sub-regions;
If division into sub-region is needed:
   Determines the optimal split plane 402 and split point for the region;
   Inserts a new split plane 402 at that point and prepares the two buffers (formed from the parallel projections on either side of the plane 402); and
   Recursively calls itself with each new sub-region.

Termination (of the recursive procedure) criteria primarily involve depth complexity in the region. One minimal, though imperfect sampling of a local region is a single pair of buffers facing each other on either side of the region. If no objects in the region overlap in the projection onto the buffers, then every pixel of every convex object not edge-on to the projection is covered in one of the two buffers. However, such a termination fails for concave objects. Further, for edge-on objects the system must rely on other views to contain the pixels. An approximation of depth complexity is computed by considering the overlap of the object's bounding boxes in the various projections. If any of the three (3) projection pairs has no overlapped boxes, subdivision terminates for that region.

Similarly, to determine a space optimal split plane 402, a cost function is defined for any potential split plane 402. The cost function is then evaluated for a large set of possible split planes 402 and the lowest cost split is chosen/selected. The cost function may include an estimate of how much more subdivision the scene would require if the given split 402 was chosen. Using the same bounding box approximation as above, the cost of a given split plane 402 is the sum of the axis-wise minimum overlaps in each sub-region. In other words, for each sub-region, the number of box overlaps is computed in each of the three (3) projections. The cost for the sub-region is the minimum of these three (3), and the cost of a given subdivision plane is the sum of the costs of each created sub-region.

Accordingly, the above described method provides an automatic method of scene decomposition that, by creating different cost functions, can create trees with a wide variety of characteristics.

In addition, packing the buffers can either be accomplished by creating individual buffers for rasterization and packing the composite tree as a copying step, or by adding an offset to the projection transform to directly construct individual buffers directly in a portion of the large composite photon tree buffer.

It may be desirable to embed this viewpoint-independent local lighting solution within a distant solution where viewpoint independence can be assumed without actually having to compute it or store hidden samples. A classic cube map can provide such embedding in a easily accessible form. The buffers are attached to the missing six (6) buffers at the top region of interest (i.e., the outward looking faces of the original box).

Such additional six buffers provides a tree with all parallel projections internally embedded in a perspective cube map of the larger scene. As noted above the photon tree structure allows the concatenation of both parallel and perspective views and operates on both in parallel when conducting lighting. Such a photon tree allows the distant scene to be sampled by direction, similar to a normal environment map cube, but the inner tree by position.

In other words, once you have a given cubic region of interest, it is desirable to embed the cube in the larger scene. Each of the split plane buffers is really a double buffer, one buffer that looks on one side of the splitting plane and the other buffer that looks on the other side of the splitting plane. For the different views (or as the cube is subdivided), buffers are obtained for positive and negative sides. From within the region of interest, one looks out into the rest of the scene (i.e., where no buffers yet exist). Therefore, one or more embodiments may create an outward looking buffer. Instead of using parallel projections, a standard cube map projection may be utilized where the camera is in the center of the region of interest and points along the axis and has a ninety (90) degree view frustum. With one buffer for each of the six views, an approximate radiosity may be obtained on the entire scene that surrounds the region of interest. For example, if the region of interest box is placed around a section in a street corner, if the camera is placed in the center of the box and one looks from the edge of the box outward (i.e., clip at the edge of the box and ignore everything inside), the result is a photograph for embedding the region of interest in the larger scene without having to draw it.

At some point in time, it will be necessary to render the outward buffers. The outward buffers can be used for this purpose. In this regard, the invention produces a region of interest/view-dependent illumination/radiosity of the outer scene while producing a view independent illumination/radiosity of the region of interest. Thus, within the region of interest, lighting is performed more accurately than the approximate lighting that is performed on the distant objects/outer scene.

As described above, the photon tree is used to illuminate objects within the region of interest. Each object in such a photon tree is surrounded by the six (6) faces of its innermost region. These faces form a structure much like a cube map, except the projections are all parallel and inward looking, and that each face of this inner most region may be but a part of a larger split plane at some higher level in the tree, unlike a cube map where each face is completely filled by its raster. This innermost region meta-cube around each object is the runtime structure accessed to use the photon tree for rendering. The member buffers of each region and the offsets needed are properties of the tree construction and may be computed once.

Given the near region inward projected cube, samples are simply accessed at runtime by selection of the face order to sample (by normal vector component length). The first three faces are used and the remaining three are back face buffers. The depth is then compared to determine the best sample among the three (3) that will be used at runtime.

In view of the above, embodiments provide for the use of splitting planes. A splitting plane is used when certain pixels cannot be viewed/resolved pursuant to projections of the existing buffers. The scene is split in half and other projections are performed outward from either side of the splitting plane. The splitting point is chosen to maximize the number of resolved pixels from the pixels that could not be resolved in prior projections. For example, if two objects overlap, as they are projected out into an axis, the pixels in between the two objects do not have any samples yet resolved. Accordingly, the goal is to place a splitting plane somewhere between the two objects such that the projection onto the sample plane would resolve all of the missing pixels.

This may be more easily understood by examining the buffers more closely. One may begin the analysis with a binary tree. A binary tree is a tree data structure in which each node has at most two children. Examining the cube structure that surrounds a given region of interest, one of the x, y, or z axis is selected and a position along the selected axis within the cube is selected as the location for the splitting plane. An examination is then performed of the two resulting sections (i.e., on either side of the splitting plane) to find the best location to further subdivide the region. The result is a tree with each parent having exactly two children that are axis aligned on the x, y, or z axis (i.e., the edges of the cube).

For example, the cube structure utilizes the original six (6) buffers. If the x-axis is used to conduct the split, a splitting plane may be placed on the middle of the x-axis. Accordingly, only two (2) new buffers are created (one on each side of the splitting plane). Buffers that are around the splitting plane (from the original projection) can be reused. Accordingly, one is only examining one-half (½) of the buffer in the x-axis (because it is split). As described above, the various buffers that are concatenated together are referred to as the photon tree. Thus, as described above, the splitting planes are used to decompose the scene and objects into the various projections.

Photon Tree Properties

Various attributes/properties/advantages may arise when the photon tree is produced as described above.

First, a photon tree is a storage structure for a large number of photons. While a photon tree may not be the most space efficient structure in that many pixels of many buffers may be empty, the advantage is that the g-buffer and photon tree may be prepared by the GPU and its rasterization, texturing and z-buffer hardware.

Another advantage of the photon tree is fast neighbor access. Since each buffer is a local parallel projection stored in a raster, near neighbor illumination values are often found in any buffer that also contains the target sample. Such storage of near neighbor values are useful for sub-surface and translucent materials, and for sample smoothing as well. For sub-surface materials, sub-surface light diffusion is integrated from near neighbors, and attenuated by the absorption of the media. The photon tree, by making these near neighbors easily accessible and geometrically simple to access, easily supports sub-surface shading computations. Such subsurface scattering and shading are discussed in more detail below.

It may also be noted that the photon tree, with the exception of surfaces that are edge-on or occluded in all views, satisfies the light field property.

Another property/advantage, is that positions on the objects in the scene can be sampled in a number of buffers, but not always the same number. This variant multiplicity can be both a drawback or an advantage, depending on use. See the description below for a method of counting the number of samples in the tree for a given area on a model.

In view of the above, with the concatenated g-buffer, a sampling of the entire scene is obtained. Further, each object in the scene (i.e., within the cube) maintains knowledge of which cell of the data structure it is located within (i.e., which box within the cube, the object is located in). Thus, each cube structure (within the primary larger cube) is represented by a data structure that maintains knowledge of the offset, size, and resolution of each of the six (6) faces that are surrounding it. Such knowledge is necessary and maintained by each data structure to determine the size of each projection and where the split is located so coordinates for the box/data structure can be provided (e.g., to a pixel shader) during a rendering operation.

### Basic Photon Tree Operations

As described above, it may be noted that buffers can all be combined. Thus, instead of making six (6) individual buffers for the original cube, one long buffer may be created that is one (1) high and six (6) long. Further, since each pixel has its own position and normal (i.e., in the g-buffer), the pixels are independent of any camera or view. In this regard, it does not matter how many times the scene is split because the values are added to the one large texture. In the prior art, the g-buffer was used for one particular view. In the invention, any number of views are placed in the same concatenated buffer.

One or more embodiments of the invention may build a photon tree utilizing a large buffer and creating additional buffers depending on the resolution desired. For example, large buffers (the top levels of a tree) may have sparse samples, but as the scene is split numerous times, there are finer and finer samples. Thus, if a buffer is 128×128, each time one of the cube faces is projected, the next 128×128 of a larger texture buffer (e.g., 1000×1000) may be allocated. As the tree is subdivided, a closer and closer boundary around individual objects within the cube is calculated. Further, as the resolution increases and becomes finer, new buffers may be desirable to accommodate the resolution. In addition, the amount/level of shading resolution can be controlled by specifying limitations on the number of subdivisions allowed and the maximum spatial sampling rate allowed.

Thus, the present invention allows the use of multiple views in a single g-buffer based on the photon tree structure. Such a capability is distinguishable from the prior art wherein only one view per buffer pixel was allowed. In this regard, prior art limitations provided for the use of a g-buffer for each desired view (resulting in multiple g-buffers).

In view of the above, when a scene is fully subdivided, there is a projection of every point in the scene in at least one of the buffers (that are all concatenated together. Thus, when a large quad/polygon is drawn covering the entire buffer, an entire scene can be lit with a single sample. In other words, all of the photons in all of the buffers are lit together by drawing the one polygon/quad. While deferred shading was used for the one view being rendered, the present invention is able to light an entire scene for all possible views regardless of what is actually being rendered. Further, while the buffer creation may take some time, the polygon/quad drawing to run a lighting pass over the buffers is relatively fast and inexpensive (from a processing perspective), and may be performed entirely on the GPU.

Once the photon tree has been created, it may be used to render any view within the region of interest in a scene wherein a large number of lights are used to illuminate the scene. There are many different operations that can utilize or take advantage of the photon tree. Some of these operations are described below.

Rasterization

One operation that may be operate on or use the photon tree is rasterization. Rasterization is a step that uses the GPU to render a part of the photon tree from geometric entities. In this regard, only a particular region of interest may actually be rendered/rasterized. Since GPU interpolation is involved, the hemispherical projection is not accurate, but all other projections are accommodated. In this regard, the geometric properties in the g-buffer for structures in the region of interest are examined and rendered/rasterized into a g-buffer.

In addition to the six buffers that surround the cubic region of interest being rendered, one may also place buffers on the outside of the cube looking outwards to see what the illumination is like from within the region of interest looking outwards. In this regard, as long as you are within the region of interest, there is no recomputation required. Instead, the values may merely be looked up in the g-buffer. Multiple passes may be required to accommodate any moving lights or shadows. In this regard, all of the static lighting is pre-computed and non-static lighting is added in later but may be performed quickly using the GPU.

Light Scattering

Scattering is the step that scatters a single sample of a light source or environment area to all of the photons in the photon tree. Scattering is performed by drawing a single quad over the entire g-buffer, running the light shader as a pixel shader on each element of the buffer, and accumulating the results in a value accumulator. If the light shader involves shadowing then there is often a preparation step to create a shadow buffer (depth buffer from the light's point of view) or other shadow accelerator. Since the shading environment is local to each photon, all photons may be handled in parallel for this step. Furthermore, if the region of the lights influence can be represented by a geometric object, then drawing that object into only the buffers that contain it gives the same result with far fewer photons (pixels) being evaluated. This can greatly speed the handling of local light sources.

Subsurface Scattering

Once a representation of the illumination the surface of the objects has been obtained, it may be desirable to compute materials that are translucent. For example, materials that are not completely opaque such that light travels through the surface (e.g., skin, marble, soap, etc.). Translucency is difficult to compute since light can travel through the object. For example, if a marble sculpture is lit from behind, anywhere the marble is thin enough, light will be visible. When light is projected onto a surface (e.g., a face), the sub-surface scattering of the light causes faces to look softer than they actually are because light is transmitted through the surface. Such sub-surface scattering also softens the edges of shadows because light is transmitted from the lit part near the edge of the shadow and into the shadow region through the object.

To compute sub-surface scattering, the application must know the light that is falling not only on the point being shaded but around/nearby and through so that an integration can be performed to determine the amount of light actually transmitted to the eye during rendering. For example, an object may be in a shadow but immediately adjacent to the edge of the shadow while a second neighbor object is in the light which would cause the first object to brighten considerably. In view of the above, a data structure is needed that allows the determination of light in neighboring pixels, and on the backsides of objects. The photon tree provides such information. In this regard, once the desired sample is located (e.g., in a positive x-buffer), neighbors can be examined and information needed to integrate the lighting may be retrieved. Furthermore, lighting information on the objects backside is also available in the meta-cube of g-buffers surrounding the object.

Re-Projection

Since the photon tree may be viewed as a data structure for holding and accessing photons and each photon is an independent point primitive, a point primitive can be transformed into a new projection where it is rendered. Such a re-projection of a point allows the creation of arbitrary projections from an existing photon tree, without re-accessing the geometry. For example, in one or more GPU shader models (available from Microsoft™), vertex shaders may have texture access. Such access allows the use of a vertex shader with the photon tree as input that transforms and outputs each photon as a point in an arbitrary projection. Note that the resulting projection may be arbitrary. Further, since points are only utilized, hemispherical and other procedural transforms may be available. Using this technique, shadow buffers may be prepared in a single quad draw directly from a photon tree. Note that the multiplicity of samples in the photon tree may assist with making a shadow buffer without holes between points, but potential holes between points are a drawback of this technique.

Swizzle

The swizzle step generalizes the notion of re-projection to include algorithmic determination of the output position. This may be as simple as a dependent texture lookup, or may involve an iterative algorithm such as ray tracing on a buffer. Refractive and reflective caustics use this technique to trace a projection's rays to the next surface in the chain until it is finally deposited on an opaque, non-reflective surface.

Light Gathering

In this operation, energy is gathered from local photons into every photon in the scene. The amount of energy transferred is determined by the brightness of the source photons, the distance between the sources and receiver and the relative orientation of the photon normals. The progressive radiosity energy-sorted scatter step ignores radiance transfer between photons that are dim but close, and convergence and quality is greatly improved by including these interactions.

There are a number of ways to perform this operation on the photon tree. A naive methodology has each photon randomly sample the entire photon tree and accumulate the radiance. However, various problems may arise with such random sampling. First, a random sample is unlikely to include a photon close enough to make a contribution. In addition, since samples may be visible in multiple buffers in the tree, there is no mechanism for preventing double counting of gathered irradiance. Further, there is no way of adding the samplings of photons in multiple views together.

A better method may operate in tree construction order. If one views the photons on a single buffer created by a tree split, all the near photons in the scene are on one of the twelve (12) inward and outward buffers of the parent cell. Randomly sampling only these buffers improves the effectiveness of the gathering operation. Data for these buffer locations and sizes in the photon map do not change for the entire region of the photon map represented by the split buffer being considered.

Using such random sampling, local gathering may be performed on the entire photon tree in a single draw. If a single integer channel is added to the photon tree indicating the ID of the nearest cell containing it, and a data texture is created with the buffer locations and sizes in the photon tree for each face of each leaf cell in the tree, then a pixel shader can index this “meta-cube” texture based on the cube ID of the photon, and each photon thus samples a different local cube. Such a meta-cube texture can be used to simplify runtime accessing.

In other words, each of the photons in the tree knows the offset and size of each of the six faces that are surrounding it. Thus, when the decomposition of the scene is performed (i.e., when the splitting planes are placed), the size of each of the projections and location of the split are tracked and the coordinates for the new box are known. The offsets and scales for each of the faces is placed into the meta-cube. During rendering the information in the meta-cube is passed to the pixel shader. In this regard, each point that is rendered can look up in the meta-cube what their illumination is. The question arises as to which buffer to look up for the data.

Depending on the surface normal, and the direction of the surface normal, there are only three possible faces/buffers that can be seen. In this regard, the surface normal would have to point the opposite direction to see the remaining three (3) faces. Thus, when searching for the data to use during rendering, the pixel need only look into three possible buffers. The first buffer that is often examined is the buffer that the surface normal faces the most (i.e., where the component of the normal is the longest). For example, if the normal has the z-component as the longest, the positive z-buffer would be examined. If the normal has the y-component the longest and it is negative, the negative y-projection buffer would be examined first. Thus, by looking at the sign of the normal and the length of the relative three (3) coordinates, a deterministic order can be created and used to determine the likely location(s) for obtaining the representation of the pixel.

To handle any over-sampling problems when creating secondary (indirect) light samples as well as gathering samples, the samples may be stratified such that they maintain a Poisson distance after super-position. Each small surface patch in the scene represented by a photon should be represented on one to three buffers, and each of the three potential buffers has a different parallel projection: x, y, or z. Accordingly, if a local cube is filled with random 3D samples that maintain a Poisson distance from one another, and the sample set is projected onto the X=0, Y=0, and Z=0 planes, there is a guaranteed non-overlapping sample set for one to three dimensions.

An additional problem during gathering is that of adding the contributions of photons with multiplicities greater than one (1). Since it is desirable for all photons to have the full irradiance values, it is desirable to add the contribution of a single photon to it's 0, 1, or 2 duals in the tree. This can be performed using a vertex shader. For each input photon, the vertex shader outputs three (3) point primitives, one transformed into each of the possible projection locations/buffers. Thereafter, normal frame buffer summing accumulates the full values in all photons.

Sample Counting

The multiplicity of samples can be counted using a technique similar to the summing algorithm above. The vertex shader can be used to produce three (3) output point primitives for each input photon, one in each of the projections in which it might be seen. Thereafter, a pixel shader can compare the incoming points to the photons in the photon tree, and increment the count for the photon if it is within a geometric tolerance (referred to as the “sample volume”). Incrementing the count is implemented as a normal frame buffer accumulation.

### Lighting Methodologies

Using these basic operations on the photon tree, solutions to a number of parts of the global illumination problem may be expressed.

Progressive Radiosity

Diffuse reflection for lights and bright regions within the scene can be computed in a manner similar to progressive radiosity. For example, all of the emitters in a scene can be sampled and a single scatter pass may be run for each sample. After the emitters have been sampled and the passes run, the accumulated direct illumination may be read. In this regard, the accumulated direct illuminations are sampled randomly (but massively), and only the N brightest samples are retained. These N samples are then sorted by radiance and the first M samples may be used as pseudo-emitters with a scatter pass each.

Image Based Lighting

In image based lighting, a scene may be lit without using actual lights. For example, a photograph of a scene (or a series of photos for more dynamic range) may be taken and used (especially if it has high dynamic range representing real world values) to light a scene. Each pixel of the photo is a virtual light. The issue is to project the light from the photograph into the scene. To provide such projections, the photos can theoretically be placed on a cube surrounding the region of interest to provide a high dynamic range value in each pixel that is used as a light. Similarly, nearby pixels may be accumulated together and used as a light. In this regard, nearby pixels (without a significant change in energy) may be gathered together into a single area for use as an indirect light source. The amount of energy that exists in a given area can define the size of the sample used. In this regard, if there is a lot of energy, more samples may be utilized while if there is not a lot of energy, fewer samples may be used.

A cube map of the scene may be used as a light source (e.g., one large colored light source surrounding the scene and illuminating it). The raster is divided into groups of samples since using every pixel as a light source would consume excessive processing. In this regard, a group is created wherein the illumination in the group of pixels does not change significantly (e.g., the pixels in the group or of the same/similar color and intensity). A default value for what constitutes a significant change maybe specified by the user or determined based on testing. If there is a lot changes between pixels, a larger sample may be necessary to identify a single group with similar properties. Each group is used as a virtual light source and a pass is made for each group. The result provides an illumination where an artificial scene is seamlessly integrated into and lit by the photograph. What the above process provides for is a series of accumulations, determining where the samples lie, and accumulating the various samples/groups of samples into the image. Such a process may be performed quickly and in a viewpoint independent fashion using the photon tree.

It may be noted that the second phase of the progressive radiosity procedure described above includes reading back the accumulated direct illumination which is sampled and used for further accumulation. Such a phase is essentially an image based lighting step. Instead of reading back the direct accumulation, any samplable image based representation (e.g., photographs) may be substituted, such as a high dynamic range (HDR) cube map.

The sample selection from an image is a process that has been the subject of much research and can be done at various quality levels, well beyond the simple “sample, sort, select” scheme described above. While the simple scheme is all that is required for diffuse indirect accumulation, image based lighting, since it includes direct as well as indirect lighting, requires more careful sampling. Thus, an additional schema of the invention samples the image and includes a Poisson area about each sample that depends on its sampled energy. This is an inverse relation such that the Poisson distance is smaller for brighter samples, so that bright areas are sampled more densely. Hierarchical schemes are also useful so that bright areas are not missed. If a mip-map (MIP Maps or pre-calculated optimized collection of bitmap images) of the incoming HDR map is prepared, one can use the higher levels of the tree for quick approximate intensity summation over image regions.

Further, the final sampling may benefit from a few steps of a relaxation method such as Lloyd's method. Lloyd's method is a method for evenly distributing samples or objects, usually points. Beginning with an initial distribution of samples or points, a relaxation step is repeatedly executed. The relaxation step computes a Voronoi diagram of the points. Each cell of the diagram is integrated and the centroid is computed. Thereafter, each point is moved to the centroid of its Voronoi cell. The methodology serves to distribute the samples more evenly.

Shadow Buffer Creation

Each of the scattering operations described above may require the creation of a shadow buffer. Such a shadow buffer may be created using a rasterization step or using the re-projection step described above. If using a re-projection step, the shadow buffer is prepared for any projection directly from the photon tree by using an atomizing vertex shader and normal z-buffer hidden surface resolution. Samples with multiplicity greater than one may benefit such a practice, filling potential holes in the shadow map.

In view of the above, we can extend the shadow buffer to include not only depth per pixel, but an illumination color as well. When the shadow buffer is prepared, the color is set to the value for the light modified by the lights goniometric distribution & any cookies or gobos attached to the light to give artificial shadows. When the shadow buffer is searched, the application merely looks up the value of the light in the particular color. Such a shadow buffer allows for varying the color/brightness of the light for every pixel in the shadow buffer. Further, extra illumination caused by caustics can be added directly to this illumination buffer.

Front/Back Illumination

Another useful property of the photon tree is the ability to quickly find the backface illumination of an object. Within a given meta-cube, if a point P has its primary sample on the +X buffer, then the primary backface sample is the projection along the x-axis and the backface illumination found in the −X buffer. This information is useful for many circumstances: diffuse transmission may be computed between the front and back faces, and a step of multi-ray specular transmission may be computed using a swizzle step. In rendering views, this can be used to compute translucency and sub-surface scattering effects, which both require front and back face near-neighbor lighting information.

Scatter-Gather Radiosity

After the above-described initial progressive steps, the solution may be further refined by performing a number of gather steps over the photon tree in the manner described above. There is a limit on the number of texture reads that can be preformed in a pixel shader. Accordingly, a complete gathering of the scene will require many draws over the photon tree, with a different sample set for each pass. The gathered radiance can continue to be gathered in multiplicious samples however, summing the contributions only once.

Caustics

Two sided refractive caustics can be added to the solution using the front-back illumination property of the photon tree. Front photons (in the light's view that are caustic producing) first ray trace against the back-facing buffer for an exit point. Thereafter, the exit ray is ray traced against the front facing buffer for intersection with the scene. When the scene intersection is found, the energy is deposited in a “caustics” channel of the shadow map. Subsequently, during a normal scatter step, the caustic channel may be added to all visible photons as a part of shadow evaluation.

The ray tracing steps on the shadow buffers may use a variety of techniques. One such technique referred to as Caustics Mapping of Shah and Pattanaik, provides for obtaining a rough distance estimate for the refracted ray, and refining the estimate by successive shadow map lookups (see Shah, M. and Pattanaik, S. Caustics mapping: An image-space technique for real-time caustics. Tech. Rep. CS-TR-50-07, University of Central Florida, August 2005, which is incorporated by reference herein).

This approach may be more easily understood by example. Suppose there is a mirror in a scene and a light is shining in the mirror, casting a bright patch on the floor. Here the light is hitting a reflective object that is generating new rays into the scene. If one can determine where the ray falls, the light can be deposited onto the scene and you are provided with a representation of the light referred to as caustics. Embodiments of the present invention combine the photon tree with a form of ray tracing.

Ray tracing is performed against a buffer of the scene. In this regard, a g-buffer has a position in space and a fixed orientation, and may be viewed as a height map (e.g., it has the world space position at each point). A ray may be marked between two points on the buffer to determine if the ray intersects any objects. Since the buffer is the sampling of the scene containing objects in the various different views, one may ray trace on the buffer itself and achieve approximate results.

In addition, the invention may utilize an additional buffer referred to as an auxiliary buffer or shadow buffer. Normally, when performing a light pass, if the light is a bright light, it is desirable to produce shadows from the light. A shadow buffer is used for this purpose. When shading is performed on a particular pixel in the g-buffer, the world position point can is known and can be projected into the shadow buffer. If the depth is less or equal to what is in the shadow buffer, it may be concluded that the hit surface is in the light. If the depth is greater than what is in the shadow buffer, then the hit surface is out of the light and no shadow is needed.

Local Reflection by Re-Projection

When rendering a final image the photon tree can be used to prepare a local environment map in either a cube-map or dual-hemispherical map by re-projection. The environment map may then be sampled in the normal way at runtime. If a local environment map is prepared for each object to be rendered, the resulting local reflections can be good. However, object self-reflection may be ignored. Further, errors may be introduced as these environment maps are shared between objects.

Ray Tracing the Photon Tree

An alternative solution for local reflection involves ray tracing directly on the photon tree. The caustics tracer described above may be extended to reflection ray tracing in the photon tree directly. Starting from the shading point in question, the reflection ray is computed and intersected with the meta-cube surrounding the object. The depth at that point, plus the distance traveled to the cube, provides the initial estimate for the intersection depth along the ray. This depth is used to make a new point along the ray, which is then projected to a new buffer location, and the depth there provides the next depth estimate. The process proceeds through a few iterations and the final value accepted as the “intersection”.

Such a process may be made faster and more reliable by using a sphere tracing concept. With sphere tracing, the raw orthogonal buffer depth is replaced with a special distance, d, that provides the distance to the closest intersection from this pixel in the hemisphere surrounding it. Using this depth as the next depth estimate greatly speeds up the ray marching process, and avoids many errors. Such use is successful and beneficial in ray traced displacement mapping on the GPU.

Participating Media

The photon tree provides a data structure sufficient to represent the influence of participating media on the static lighting. For example, if a shadow of a cloud is generated, the cloud's effect on the geometry can be stored. Atmospherics are often represented by volume primitives that contain a number of slices that can be recomputed quickly to stay orthogonal to the view. Producing such a set from the shadow buffers point of view allows summing through the slices and creating a composite attenuation map for the atmosphere. This can be used to attenuate the light during a shadowed scatter step, leaving the cloud shadow on the scene geometry.

In addition to the above, the issue arises regarding lighting of the atmosphere. In this regard, atmosphere primitives may be filled with a sampling of photons and the photons added to the photon tree. The result provides for the accumulation of atmosphere photons that provide an approximate lighting solution for the volume. In addition, instead of collapsing the atmosphere layers into a single attenuation buffer, the entire set may be saved with a z depth for each layer. Using this information, the atmosphere samples can place themselves in the stack and compute correct, if sparsely sampled, shadows of atmospheres on themselves.

Light Movement

Light sources may often be mobile or moving. For example, it may be necessary to simulate a particular lighting condition (e.g., subtle lighting over a particular primary character to drive a story line). The use of the photon tree and the various accumulations described above, provide the ability to quickly and easily simulate such light movement. For example, the photon tree and shadow buffer provide for a representation of the accumulation of light. Rather than recomputing all of the calculations as a light moves, the old light may merely be subtracted and added at a new position. Thus, two passes may be conducted—one pass to remove the light and another to add the light to the new location. Such passes may be performed quickly and easily while maintaining a high frame per second rate (e.g., 10-15 fps).

Dithering

With an area light and shadows from the light, there are soft rather than hard shadows. With a point light, there are sharp shadows. To simulate the soft shadows, a series of samples of the area where the light is located may be obtained. Further, a series of lights (e.g., 10 lights) may be projected into the scene from the location samples. Since the lights are in slightly different positions, the projections will overlap and result in the simulation of a soft shadow.

However, if the shadow is broad enough and there are only a small number of samples (e.g., 10 samples), visible banding may occur in the accumulation. Additional samples may be added to overcome the bands, or the banding may be minimized by examining the neighboring pixels and averaging/smoothing them. However, such examination of neighboring pixels may be processor intensive and impractical.

To overcome the above disadvantages, dithering may be used. In dithering, a modified accumulation is performed against the photon tree or the final g-buffer in a deferred shading approach. Instead of drawing one large quad, accumulating every pixel within the quad, a noise texture may be superimposed over the quad. The noise texture is compared to the value stored in the photon tree for a particular pixel or to a constant value. If the value is above a value on the noise texture for the pixel, the pixel may be drawn/rendered (i.e., the shader may increase or change a value for the pixel), otherwise, it is not drawn.

### Logical Flow

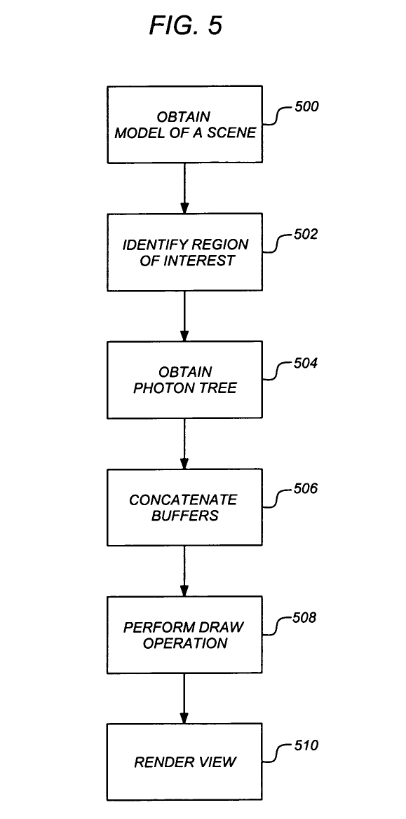

FIG. 5 illustrates the logical flow for conducting global illumination in accordance with one or more embodiments of the invention. At step 500, a three-dimensional (3D) model of a scene is obtained in a computer graphics application. Such obtaining may consist of retrieving/opening a saved file, creating a new scene, or receiving a file across a network connection (e.g., the Internet or an Intranet).

At step 502, a section of the scene is identified as a region of interest. At step 504, a photon tree is obtained/created/formed. Such a photon tree comprises a set of buffers that represents the region of interest. Every pixel in the region of interest necessary for every view is represented in at least one buffer in the set of buffers. Thus, the photon tree satisfies the criteria for a light field as described above.

The photon tree may be obtained by forming six inward looking buffers on each face of a cube that encompasses the region of interest. As described above, a determination is then made if the region of interest requires division into sub-regions. If a division is required, an optimal split plane and split point for the region is determined. The new split plane is inserted at the split point. Two new buffers are then prepared formed by parallel projections on both sides of the split plane. Such buffer preparation may merely utilize space in a large buffer of the GPU. These steps are then repeated for each of the sub-regions.

Once the cube with all of the appropriate divisions has been obtained/formed, the set of buffers representing the photon tree may be attached to six additional buffers comprised of outward looking faces of the cube. Such an action inserts the region of interest into the larger scene. These outward looking buffers may be prepared with a perspective projection from the center of the cube, providing distant illumination in the form of a traditional cubic environment map.

In one or more embodiments, each of the buffers in the set of buffers is prepared using a parallel, axis aligned projection. Further, each of the projections comprises a projection of objects in the 3D model of the scene onto a 2D plane.

In additional embodiments, every pixel for every view is represented in a buffer in the form of photon elements. Such photon elements comprise (or consist) or a world space position, a world space normal, a raw color, a material index and an accumulator for photon values. Such properties may be used when conducting a lighting and/or display operation.

At step 506, the set of buffers are concatenated into a single large buffer. At step 508, one or more full screen draw operations are performed over the single large buffer. Accordingly, a single large quad is used to conduct the draw operation. Such a draw operation may include a lighting operation on every pixel represented in the set of buffers. In this regard, the draw operation may comprise the execution of a light shader as a pixel shader on each of the one or more photon elements and accumulating the results in the accumulator. For example, if a light is moved, the lighting operation may consist of two passes, once to remove the original lighting (e.g., by adjusting the values in the photon elements), and a second pass to add the light to the new location. Many operations may be included in step 508 as described above with respect to the various lighting and basic operations performed on the photon tree.

Further, shadows for each point may be obtained by projecting the point into a shadow buffer prepared for the light and comparing the point's projected distance to the closest illuminated distance, which is stored in the shadow buffer. If the point is not in shadow, complex illumination information may be obtained from the illumination channel of the shadow buffer.

At step 510, the view of the region of interest is rendered on a display device based on the lighting operation and photon tree. It may be understood that such a display device may include a computer monitor, a television screen, a film, or could include a disc or tape that will eventually be used to display the scene. The implementation of step 510 is intended to describe the rendering of view using the lighting operation (i.e., from the full screen draw operation) and the photon tree into a desirable form that may be used at a later time.

In addition to the above, it should be noted that the photon tree may be obtained and the single full screen draw operation may be performed by a graphics processing unit of a computer. The use of such a GPU significantly increases the execution time for conducting the various steps.

Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer implemented method for conducting global illumination, comprising:
(a) obtaining a three-dimensional (3D) model of a scene in a computer graphics application;
(b) identifying a section of the scene as a region of interest;
(c) obtaining a photon tree comprised of a set of buffers that represents the region of interest, wherein every pixel in the region of interest necessary for every view is represented in at least one buffer in the set of buffers;
(d) concatenating the set of buffers into a single large buffer;
(e) performing one or more full screen draw operations over the single large buffer, wherein each single full screen draw operation performs a lighting operation on every pixel represented in the set of buffers;
(f) rendering, on a display device, a view of the region of interest based on the lighting operation and photon tree.

2. The method of claim 1, wherein the obtaining the photon tree comprises:
(a) forming six inward looking buffers on each face of a cube that encompasses the region of interest;
(b) determining if the region of interest requires division into sub-regions;
(c) if the region of interest requires division into sub-regions:
(i) determining an optimal split plane and split point for the region of interest;
(ii) inserting a new split plane at the split point;
(iii) preparing two new buffers formed by parallel projections on both sides of the split plane; and
(iv) repeating steps (b)-(c) for each of the sub-regions.

3. The method of claim 2, further comprising attaching the set of buffers to six additional buffers comprised of outward looking faces of the cube.

4. The method of claim 1, wherein:
each of the buffers in the set of buffers is prepared using a parallel, axis-aligned projection; and
a projection comprises a projection of objects in the 3D model of the scene onto a 2D plane.

5. The method of claim 1, wherein every pixel for every view is represented in at least one buffer in a form of one or more photon elements comprising:
a world space position;
a world space normal;
a raw color;
a material index, and
an accumulator for photon values.

6. The method of claim 5, wherein each of the one or more full screen draw operation comprises running a light shader as a pixel shader on each of the one or more photon elements and accumulating results in the accumulator.

7. The method of claim 1, wherein a graphics processing unit is used to obtain the photon tree and perform the one or more full screen draw operations.

8. An apparatus for conducting global illumination in a computer system comprising:
(a) a computer having a memory;
(b) a computer graphics application executing on the computer, wherein the application is configured to:
(i) obtain a three-dimensional (3D) model of a scene;
(ii) identify a section of the scene as a region of interest;
(iii) obtain a photon tree comprised of a set of buffers that represents the region of interest, wherein every pixel in the region of interest necessary for every view is represented in at least one buffer in the set of buffers;
(iv) concatenate the set of buffers into a single large buffer;
(v) perform a one or more full screen draw operation over the single large buffer, wherein each single full screen draw operation performs a lighting operation on every pixel represented in the set of buffers;
(vi) render, on a display device, a view of the region of interest based on the lighting operation and photon tree.

9. The apparatus of claim 8, wherein the application is configured to obtain the photon tree by:
(a) forming six inward looking buffers on each face of a cube that encompasses the region of interest;
(b) determining if the region of interest requires division into sub-regions;
(c) if the region of interest requires division into sub-regions:
(i) determining an optimal split plane and split point for the region of interest;
(ii) inserting a new split plane at the split point;
(iii) preparing two new buffers formed by parallel projections on both sides of the split plane; and
(iv) repeating steps (b)-(c) for each of the sub-regions.

10. The apparatus of claim 9, further comprising attaching the set of buffers to six additional buffers comprised of outward looking faces of the cube.

11. The apparatus of claim 8, wherein:
each of the buffers in the set of buffers is prepared using a parallel, axis-aligned projection; and
a projection comprises a projection of objects in the 3D model of the scene onto a 2D plane.

12. The apparatus of claim 8, wherein every pixel for every view is represented in at least one buffer in a form of one or more photon elements comprising:
a world space position;
a world space normal;
a raw color;
a material index; and
an accumulator for photon values.

13. The apparatus of claim 12, wherein each of the one or more full screen draw operations comprises running a light shader as a pixel shader on each of the one or more photon elements and accumulating results in the accumulator.

14. The apparatus of claim 8, wherein a graphics processing unit is used to obtain the photon tree and perform the one or more full screen draw operations.

15. An article of manufacture comprising a program storage medium readable by a computer and embodying one or more instructions executable by the computer to perform a method for conducting global illumination in a computer system, the method comprising:
(a) obtaining a three-dimensional (3D) model of a scene in a computer graphics application;
(b) identifying a section of the scene as a region of interest;
(c) obtaining a photon tree comprised of a set of buffers that represents the region of interest, wherein every pixel in the region of interest necessary for every view is represented in at least one buffer in the set of buffers;
(d) concatenating the set of buffers into a single large buffer;
(e) performing a one or more full screen draw operations over the single large buffer, wherein each single full screen draw operation performs a lighting operation on every pixel represented in the set of buffers;
(f) rendering, on a display device, a view of the region of interest based on the lighting operation and photon tree.

16. The article of manufacture of claim 15, wherein the obtaining the photon tree comprises:
(a) forming six inward looking buffers on each face of a cube that encompasses the region of interest;
(b) determining if the region of interest requires division into sub-regions;
(c) if the region of interest requires division into sub-regions:
(i) determining an optimal split plane and split point for the region of interest;
(ii) inserting a new split plane at the split point;
(iii) preparing two new buffers formed by parallel projections on both sides of the split plane; and
(iv) repeating steps (b)-(c) for each of the sub-regions.

17. The article of manufacture of claim 16, further comprising attaching the set of buffers to six additional buffers comprised of outward looking faces of the cube.

18. The article of manufacture of claim 15, wherein:
each of the buffers in the set of buffers is prepared using a parallel, axis-aligned projection; and
a projection comprises a projection of objects in the 3D model of the scene onto a 2D plane.

19. The article of manufacture of claim 15, wherein every pixel for every view is represented in at least one buffer in a form of one or more photon elements comprising:
a world space position;
a world space normal;
a raw color;
a material index; and
an accumulator for photon values.

20. The article of manufacture of claim 19, wherein each of the one or more full screen draw operations comprises running a light shader as a pixel shader on each of the one or more photon elements and accumulating results in the accumulator.

21. The article of manufacture of claim 15, wherein a graphics processing unit is used to obtain the photon tree and perform the one or more full screen draw operations.
